(19) United States
(12) Patent Application Publication
(10) Pub. No.: US 2007/0029369 A1
(43) Pub. Date: Feb. 8, 2007

(54) Transient liquid phase bonding of dissimilar metals

(75) Inventors: William B. Watkins, Tequesta, FL (US); Joseph C. Barone, Palm Beach Gardens, FL (US)

Correspondence Address: BACHMAN & LAPOINTE, P.C. (P&W), 900 CHAPEL STREET, SUITE 1201, NEW HAVEN, CT, 06510-2802, US

(73) Assignee: United Technologies Corporation

(21) Appl. No.: 11/196,611

(22) Filed: Aug. 2, 2005

(51) Int. Cl. B23K 31/02

(52) U.S. Cl. 228/183; 228/165

(57) ABSTRACT

In a method for forming a component, a braze material is assembled between first and second wall portions to form a sandwich. The first wall portion consists essentially of copper or a copper-based alloy. The second wall portion comprises at least one non-copper-based alloy. The sandwich is heated. The heating melts the braze material to cause a transient liquid phase bonding of at least a portion of the first wall portion to the second wall portion.

### BACKGROUND OF THE INVENTION

The invention relates to transient liquid phase bonding. More particularly, the invention relates to transient liquid phase bonding of a copper alloy to a non-copper alloy.

The difficulty of blind welding has plagued the field of milled channel heat exchangers. One example of a milled channel heat exchanger is the wall of a rocket nozzle as shown in Damgaard et al. “Laser Welded Sandwich Nozzle Extension for the RL60 Engine” (AIAA-2003-4478), AIAA, Reston, Va., 2003, the disclosure of which is incorporated by reference herein as if set forth at length. In an exemplary milled channel heat exchanger, an array of channels are milled in a base material leaving ribs between the channels. A cover sheet or panel is placed atop the ribs and welded thereto (e.g., via laser or e-beam from the side of the sheet facing away from the base layer).

Copper alloys have been proposed for heat exchanger use. US Patent Application 20040011023-A1 references use of NASA Glenn Research Center alloy GRCop-84 (Cu-8Cr-4Nb nominal composition by atomic percent) for heat exchanger use. U.S. patent application Ser. No. 11/011,314 discloses a heat exchanger wall structure formed as a composite of such a copper alloy and a dissimilar material.

### SUMMARY OF THE INVENTION

One aspect of the invention involves a method for forming a component. A braze material is assembled between first and second wall portions to form a sandwich. The first wall portion consists essentially of copper or a copper-based alloy. The second wall portion comprises at least one non-copper-based alloy. The sandwich is heated. The heating melts the braze material to cause a transient liquid phase bonding of at least a portion of the first wall portion to the second wall portion.

In various implementations, the method may further include milling the relieved areas in the first wall portion. The first wall may consist essentially of Cu-8Cr-4Nb. The second wall may consist essentially of a nickel-based superalloy, stainless steel, or iron-based superalloy. The component may comprise a heat exchanger for a rocket chamber or nozzle.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a schematic view of a rocket engine combustion chamber and exhaust nozzle.

FIG. 2 is a cross-sectional view of a heat exchanger wall of the nozzle of the engine of FIG. 1.

FIG. 3 is an exploded pre-integration view of the wall of FIG. 2.

FIG. 4 is a photomicrograph of an integration region of the wall of FIG. 2.

FIG. 5 is a sectional view of an alternate heat exchanger.

Like reference numbers and designations in the various drawings indicate like elements.

### DETAILED DESCRIPTION

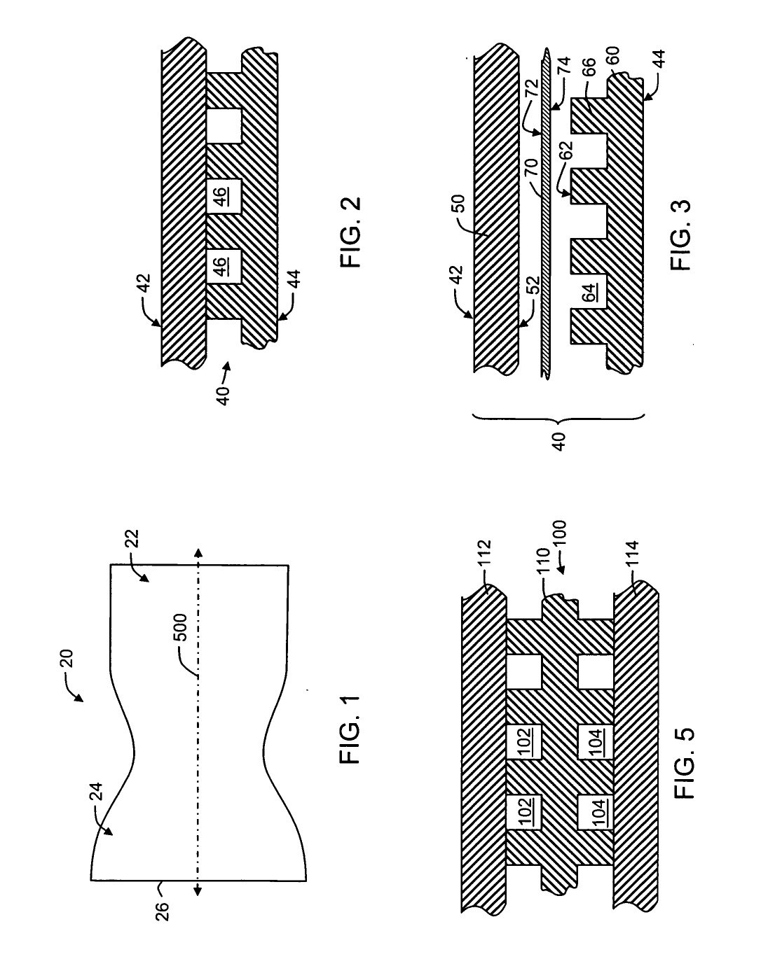

FIG. 1 shows a rocket engine 20 having a combustion chamber 22. A nozzle 24 extends downstream from the combustion chamber to an outlet 26. The nozzle may be bell-shaped and generally symmetric about a central longitudinal axis 500 of the engine. FIG. 2 schematically shows a heat exchanger wall structure 40 of the chamber 22 and nozzle 24. The wall 40 has an outboard surface 42. Opposite the outboard surface 42 is an inboard surface 44 along the chamber/nozzle interior and exposed to the exiting exhaust gases. The wall 40 includes internal channels 46. In engine operation, the channels accommodate a flow of a heat exchange fluid. An exemplary heat exchange fluid is pre-combustion propellant or a component thereof (e.g., a monopropellant or one of a fuel and oxidizer). The fluid receives heat from the exhaust gases to cool the wall 40.

The wall 40 may be assembled by integrating a multi-layer sandwich structure. FIG. 3 is an exploded view of exemplary sandwich components. A first layer 50 has a first surface that ultimately forms the wall outboard surface 42. The first layer 50 has a second surface 52 opposite the first surface. The first layer 50 may be selected for structural or environmental properties (e.g., strength, corrosion resistance, thermal conductivity, and/or erosion resistance, etc.).

A second layer 60 has a first surface that ultimately forms the wall inboard surface 44. The second layer 60 has a second surface 62 opposite the first surface 44. In an exemplary non-limiting method of manufacture, one or more open channels 64 are milled below the surface 62. The channels 64 define relieved/recessed areas separated by intact raised/elevated areas or ribs 66 joined by intact material. The material of the second layer 60 may be selected for ease of machining or other forming, high heat transfer, light weight, and the like. Exemplary materials are copper-based alloys. The layers and sandwich may be flat or shaped otherwise. For example, the layers and sandwich may be frustoconical with the channels running longitudinally as in a rocket nozzle precursor (subsequently formed into a bell shape).

To integrate the first and second layers, the sandwich includes a bonding layer 70 between the first layer 50 and second layer 60. The bonding layer 70 has first and second opposed surfaces 72 and 74. When the sandwich is assembled, the surfaces 72 and 74 contact the surfaces 52 and 62, respectively. Exemplary bonding material is a transient liquid phase-forming diffusion braze material. TLP diffusion bonding of nickel-based superalloys to each other is well known (see, e.g., U.S. Pat. No. 3,678,570). Upon heating, one or more components of the braze material diffuse into the adjacent materials. The diffusing components temporarily depress the melting points of the adjacent materials forming a transient liquid phase. As further diffusion reduces the concentration of these components, the depressed melting points return toward the original melting points forming an integrated solid structure. Exemplary braze materials for bonding the present combination of dissimilar materials include nickel-based superalloys having boron concentrations of 1-4% by weight and silicon concentrations of 4-8% by weight, typically in inverse proportion. Exemplary thicknesses of the braze materials are 37-50 μm, more broadly 25-150 μm.

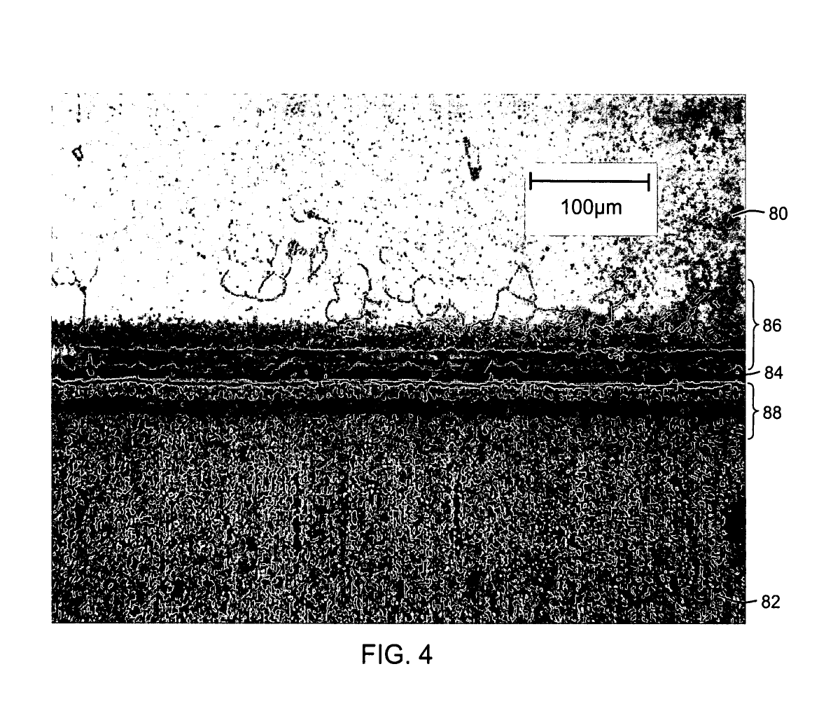

FIG. 4 shows an exemplary junction between two such materials. A first material 80 may be essentially microstructurally unaltered precipitation-hardenable iron-based superalloy. The illustrated first material is alloy A286 (UNS S66286, nominal composition 25.5 Ni, 15 Cr, 1.25 Mo, 2.1 Ti, 0.3 V, balance Fe by weight %). A second material 82 may be essentially unaltered GRCop-84 copper alloy. The two materials have been joined by a transient liquid phase bonding process utilizing a 75 μm thick braze material of MBF-20 (AMS 4777, nominal composition 7 Cr, 3 Fe, 4.5 Si, 3.2 B, balance Ni by weight %). Heating was by immersion in an electrical resistance vacuum oven to a peak temperature of 1010° C. In the resulting junction microstructure, it is believed that FIG. 4 shows a fine layer 84 of generally intact braze material. On either side of the braze material 84 is a diffusion region 86 and 88.

Within each of the diffusion regions 86 and 88, differential transport of various components is believed to cause a layered appearance. It is known that boron diffuses rapidly in solid solution, and that boron reacts with chromium to form chromium borides of various stoichiometries. The string-like structures in region 86 are believed to be chromium borides resulting from diffusion of boron from the original braze material into the iron-based alloy. It is believed that similar boron diffusion and reaction with chromium occur in region 88, in which the string-like structures appear heavier and thicker.

Destructive strength testing has produced mostly failures within the copper alloy rather than joint separation. This confirms joint integrity. Exemplary measured tensile strengths were about 400 Mpa. Even the failed joints had exemplary measured tensile strengths in the vicinity of 90% of the ultimate tensile strength of the GRCop-84 copper alloy. Similar microstructure has been observed with first materials of nickel-based superalloys (e.g., nickel alloy 625 (UNS N06625)) and stainless steel (e.g., SS 347 (UNS S34700)). Similar microstructure also been observed with MBF-30 braze material (AMS 4778, nominal composition 4.5 Si, 3.2 B, balance Ni by weight %).

FIG. 5 shows an alternate heat exchanger 100 that may be formed by similar methods. A first group of channels 102 is milled on one side of a copper alloy layer 110 and a second group of channels 104 is milled on the opposite side, leaving a web therebetween. Non-copper layers 112 and 114 (e.g., similar to the first layer 50 of FIG. 3) are TLP bonded to the respective sides of the layer 110 to enclose the respective channels 102 and 104. Such a configuration may be used to provide heat exchange between first and second fluid flows in the channels 102 and 104, respectively. Although the illustrated channels 102 and 104 are parallel such as in a parallel flow or counterflow heat exchanger, other configurations, including crossflow, are possible.

One or more embodiments of the present invention have been described. Nevertheless, it will be understood that various modifications may be made without departing from the spirit and scope of the invention. For example, details of the particular component to be formed may influence details of any particular implementation. Furthermore, while heat exchangers for rocket applications were described in some embodiments herein, this invention is not limited to such. This invention relates to any copper-based alloy being transient liquid phase bonded to a non-copper-based alloy. Accordingly, other embodiments are within the scope of the following claims.

What is claimed is:

1. A method for forming a component comprising:
assembling a braze material between first and second wall portions to form a sandwich, wherein:
the first wall portion consists essentially of copper or a copper-based alloy; and
the second wall portion comprises at least one non-copper-based alloy; and
heating the sandwich, the heating melting the braze material to cause a transient liquid phase bonding of at least a portion of the first wall portion to the second wall portion.

2. The method of claim 1 wherein:
said component comprises a heat exchanger.

3. The method of claim 1, the first wall portion comprising a plurality of raised areas separated by relieved areas, and further comprising:
milling said relieved areas in the first wall portion.

4. The method of claim 3 wherein:
said milling comprises mechanical milling.

5. The method of claim 1 wherein before the heating:
said first wall consists essentially of copper alloy having more than impurity levels of chromium and niobium.

6. The method of claim 1 wherein before the heating:
said first wall consists essentially of Cu-8Cr-4Nb by atomic percent; and
said second wall consists essentially of a nickel-based superalloy, stainless steel, or iron-based superalloy.

7. The method of claim 1 wherein:
the braze material comprises at least one of:
a Ni-based alloy with at least 1% B, by weight;
a Ni-based alloy with at least 1.5% B and at least 4% Si, by weight;
a Ni-based alloy having a nominal composition of about 7% Cr, 3% Fe, 4.5% Si, 3.2% B, balance Ni, by weight; and
a Ni-based alloy having a nominal composition of about 4.5% Si, 3.2% B, balance Ni, by weight.

8. The method of claim 1 wherein:
the heating comprises heating in an electrical resistance vacuum oven.

9. The method of claim 1 wherein:
the heating is to a peak temperature of about 1000-1035° C.

10. The method of claim 1 wherein:
the bonding provides a joint ultimate tensile strength of at least 90% of an ultimate tensile strength of the copper or the copper-based alloy.

11. The method of claim 1 wherein:
the bonding provides a joint ultimate tensile strength of at least 100% of an ultimate tensile strength of the copper or the copper-based alloy.

12. The method of claim 1 used to manufacture a rocket nozzle or combustion chamber.

13. A joined combination of first and second metallic members comprising:
a first layer of said first metallic member consisting essentially of one of a nickel-based superalloy, stainless steel, or iron-based superalloy;
a second layer of said second metallic member consisting essentially of copper or a copper-based alloy; and
a transition region joining the first and second layers and including:
a first region proximate the first layer and having a higher boron content than the first layer; and
a second region proximate the second layer and having a higher boron content than the second layer.

14. The combination of claim 13 wherein the transition region further comprises:
a layer between the first and second regions and consisting essentially of at least one of:
a Ni-based alloy with at least 1% B, by weight;
a Ni-based alloy with at least 1.5% B and at least 4% Si, by weight;
a Ni-based alloy having a nominal composition of about 7% Cr, 3% Fe, 4.5% Si, 3.2% B, balance Ni, by weight; and
a Ni-based alloy having a nominal composition of about 4.5% Si, 3.2% B, balance Ni, by weight.

15. The combination of claim 13 wherein the transition region provides a joint ultimate tensile strength of at least 90% of an ultimate tensile strength of the second metallic member.

16. The combination of claim 13 wherein the transition region provides a joint ultimate tensile strength of at least 100% of an ultimate tensile strength of the second metallic member.

17. The combination of claim 13 forming at least a portion of a combustion chamber or a rocket nozzle.

18. The combination of claim 13 forming at least a portion of a heat exchanger wherein the transition region divides first and second channels or channel portions said channels or channel portions positioned between the first and second layers.

19. The combination of claim 13 wherein:
the first and second layers each have local thicknesses in excess of 1.0 mm.
